(19) United States
(12) Patent Application Publication
(10) Pub. No.: US 2011/0182720 A1
(43) Pub. Date: Jul. 28, 2011

(54) GAS TURBINE SHROUD WITH CERAMIC ABRADABLE COATINGS

(76) Inventors: Yoshitaka KOJIMA, Hitachi (JP); Hideyuki Arikawa, Mito (JP); Akira Mebata, Kitaibaraki (JP); Tadashi Kasuya, Hitachi (JP); Hiroyuki Doi, Tokai (JP); Kunihiro Ichikawa, Hitachinaka (JP)

(21) Appl. No.: 13/012,017

(22) Filed: Jan. 24, 2011

(30) Foreign Application Priority Data
Jan. 25, 2010 (JP) 2010-012729
Jan. 19, 2011 (JP) 2011-008379

(51) Int. Cl. F01D 11/12; B05D 3/12

(52) U.S. Cl. 415/173.4; 427/289

(57) ABSTRACT

There is provided a gas turbine shroud including a ceramic abradable coating used as a gap adjusting component that can reduce a fluid leakage from a gap and increase turbine efficiency. A gas turbine ceramic abradable coating includes a bond layer, a thermal barrier ceramic layer, and a porous ceramic abradable layer (hardness may be RC15Y: 80±3). A slit groove is provided in the porous ceramic abradable layer by machining. A width of a rectangular section of the ceramic abradable layer divided by the slit groove may be set to a range of 2 to 7 mm.

### BACKGROUND OF THE INVENTION

(1) Field of the Invention

The present invention relates to a gas turbine shroud used for thermal power plants or combined power plants, and more particularly to a gas turbine shroud including a ceramic abradable coating used for adjusting a gap between a moving blade and a stationary body of a gas turbine.

(2) Description of related art

Work efficiency of a gas turbine used in power plants is influenced by an amount of fluid that rotates a turbine blade to generate power (rotating torque). Turbine performance depends on a gap adjusting technique for reducing a fluid leakage from a gap between a stationary part and a rotating part (moving blade) of a turbine. The gap adjusting technique is required to have a function (abradability) such that even if the stationary part and the rotating part are brought into contact with each other, both the stationary part and the rotating part are not damaged, and only a seal material is rubbed and worn down. Thus, by providing the seal material in the gap between the stationary part and the rotating part, the gap is substantially eliminated, a fluid leakage from the gap is minimized, and the efficiency is significantly increased. In a gas turbine, ceramic with little oxidation damage is particularly required for adjusting a gap between a first stage moving blade and a stationary body (first stage shroud) because an operating temperature is 800° C. or more.

For a ceramic abradable coating, for example, JP-A-2006-36632 proposes a method of applying an abradable coating of ceramic. A method of applying an abradable ceramic coating having a defined grid pattern to a substrate includes the steps of: performing atmospheric plasma spraying of an initial bond coat on the substrate; applying a high-density vertical-crack heat insulating coating; performing heat treatment of the initial bond coat and the heat insulating coating; applying an abradable ceramic coating having a defined grid pattern onto the heat insulating coating; and performing heat treatment of the abradable ceramic coating.

In this method, the bond layer on the substrate and the high-density vertical-crack heat insulating coating are thermal barrier coatings (TBC), and a porous ceramic abradable coating is formed on a surface of the coating in a grid pattern. The ceramic abradable coating is provided on a hot gas path surface of a shroud, and faces a moving blade tip of a Ni-based heat-resistant alloy.

As a method of applying an abradable ceramic coating having a grid pattern onto a substrate, a method of spraying using a masking material and a method of spraying with drawing a grid pattern using a small gun with a low output are provided. For the method using the masking material, it has revealed from the result of the inventors' study that, in porous ceramic spraying, a homogeneous porous film cannot be obtained because of the influence of the masking material. Particularly, it has revealed that sufficient sealability cannot be ensured for an end of a spray coating having an angular section.

From the result of the study of a wear element test of the abradable ceramic coating against a Ni-based heat resistant alloy, it has also revealed that a part of the spray coating is damaged and lost when using a spray coating having an angular section.

Meanwhile, it has been also found that when using a smooth flat abradable ceramic coating which does not have such a shape, friction heat caused by wear is not dissipated, and wear debris generated by wear cannot be discharged, a Ni-based heat resistant alloy is seized, and abradability cannot be obtained.

Thus, a ceramic abradable coating requires both abradability and long-term durability. The known example has a problem in long-term durability.

For example, JP-A-2006-104577 proposes an abradable coating having microcracks (40 to 50 microcracks per inch with an interval of 6.4 to 0.5 mm) in a coating vertical direction by plasma spraying of a gadolinia zirconia coating. In this case, an abradable coating is obtained with a microcrack formed under a particular spraying condition, and machining or heat treatment is unnecessary. Widths of the microcrack and a crack groove are not clearly described, but it cannot be supposed that the widths reach a millimeter order. From the result of the inventors' study of the abrasion element test with the Ni-based heat resistant alloy, an advantage of the high-density vertical-crack heat insulating coating in JPA-2006-36632 as a crack heat insulating coating has been sufficiently confirmed. However, it has been also found that friction heat caused by wear is not dissipated, wear debris generated by wear is not discharged, a Ni-based heat resistant alloy is seized, and abradability cannot be obtained.

For example, JP-A-6-57396 proposes a method of forming a heat insulating spray layer, in which a densified spray layer of ceramic powder having a high heat insulating property is formed on a substrate, and mixed powder of ceramic powder having a high heat insulating property and a predetermined amount of Si₃N₄ powder is sprayed onto the spray layer to form a spray layer having high porosity. In this case, a method of forming a porous ceramic layer is described in detail, but the method is intended to form a ceramic heat insulating spray layer, and means for ensuring abradability and long-term durability required for a ceramic abradable coating is not proposed.

The present invention has an object to provide a gas turbine shroud including a ceramic abradable coating used as a gap adjusting component that can reduce a fluid leakage from a gap and increase turbine efficiency.

### BRIEF SUMMARY OF THE INVENTION

According to a gas turbine shroud of the present invention, a ceramic abradable coating is placed on a hot gas path surface of the shroud facing a gas turbine moving blade, the ceramic abradable coating being obtained by spraying a bond layer on a substrate, spraying a thermal barrier ceramic layer on the bond layer, spraying an abradable ceramic layer on the thermal barrier ceramic layer, and forming a slit groove in the abradable ceramic layer by machining.

According to the present invention, abradability and long-term durability are ensured. Thus, the present invention is applied to a shroud that faces a gas turbine moving blade, thereby substantially eliminating the gap for a long term, minimizing a fluid leakage from the gap, and significantly increasing efficiency for a long term.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 shows an example of an abradable coating in an embodiment of the present invention;

FIG. 2 shows an example of an abradable coating in a known art;

FIG. 3 shows a relationship between porosity and hardness (RC15Y) of porous ceramic in the present invention;

FIG. 4 is a schematic view of a high temperature wear test used for evaluating abradability;

FIG. 5 is a sketch of a gas turbine shroud;

FIG. 6 is a sketch of a shroud having an abradable coating in the present invention;

FIG. 7 is a configuration diagram of an abradability test device by high speed rotation; and

FIG. 8 is a sectional schematic diagram of main parts of a power generation gas turbine.

### DETAILED DESCRIPTION OF THE INVENTION

Now, the present invention will be described in detail.

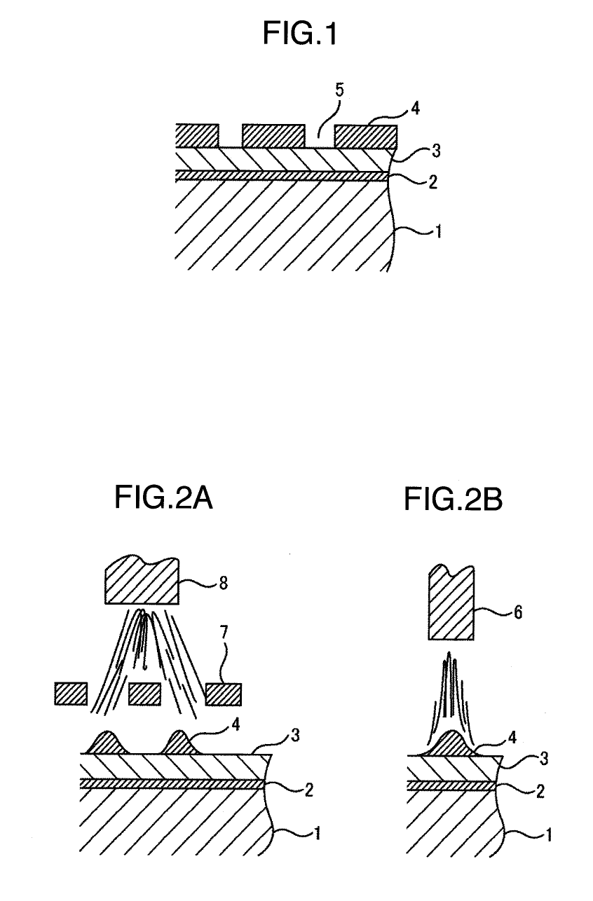

FIG. 1 shows an example of a sectional shape of a ceramic abradable coating obtained by a method of forming a gas turbine ceramic abradable coating in the present invention.

A bond layer 2 is provided on a substrate 1. A thermal barrier ceramic layer 3 is provided thereon, and a ceramic abradable layer 4 having a slit groove 5 is provided thereon.

FIGS. 2A and 2B show a method of forming an abradable coating in JP-A-2006-36632. FIG. 2A shows a method of drawing a ceramic abradable layer of a grid pattern by spraying using a masking. FIG. 2B shows a method of drawing a grid pattern by spraying using a small gun. In those known methods, the ceramic abradable layer of the drawn grid pattern has an angular section, while the ceramic abradable layer has a rectangular section in the present invention.

The requirements to be satisfied by the present invention are as follows: 1. abradability at a temperature of a shroud exposed to a combustion gas of a gas turbine, 2. thermal stress (repeated heating and cooling) at start and stop, and 3. durability to long-time exposure at high temperature. These requirements have been studied, and a ceramic abradable coating that meets all the requirements has been found.

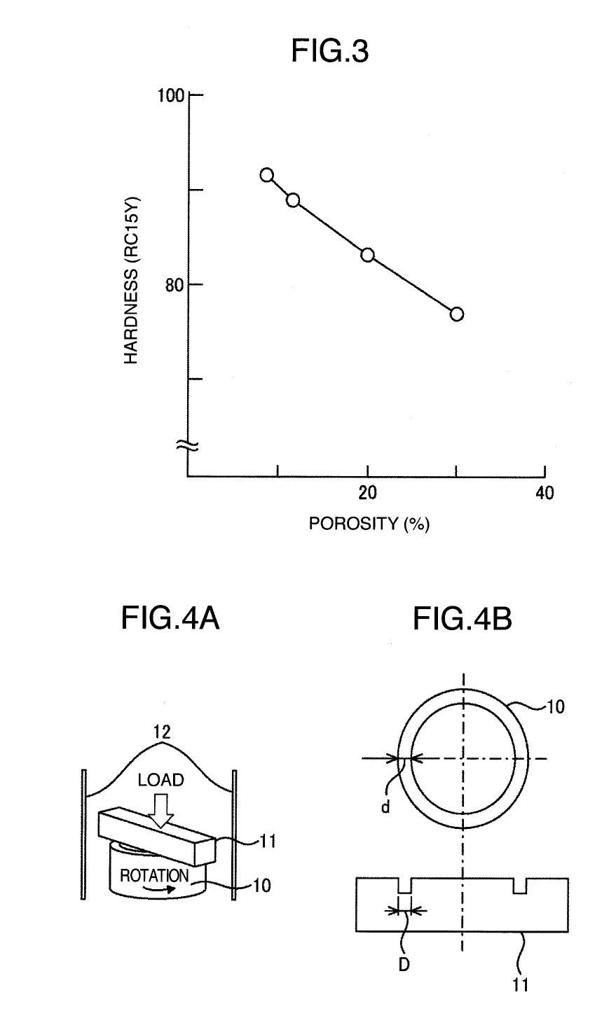

For abradability at a temperature of a shroud exposed to a combustion gas of a gas turbine, ZrO₂-based ceramic ensures sufficient heat resistance at a temperature of a shroud exposed to a combustion gas of about 800 to 1000° C. However, for a combination of ceramic and a moving blade material (a Ni-based heat resistant alloy), the moving blade material is worn down and damaged unless ceramic is made porous and sufficiently reduced in hardness. A ceramic layer is hardly reduced in hardness even at high temperature, while the Ni-based heat resistant alloy is significantly reduced in hardness at 500° C. or more to about 1/10 of the hardness at room temperature. Hardness of a ceramic abradable layer is a very important parameter, and porous ceramic is thus required for reducing hardness. Porous ceramic is formed by spraying mixed powder of ZrO₂-based powder and polyester powder. A ratio of the mixed powder can be changed to adjust porosity of ZrO₂-based ceramic. (The porosity is calculated from an area ratio of a ceramic part observed in a sectional structure.) FIG. 3 shows a relationship between porosity and hardness (RC15Y) of porous ceramic in the present invention. It has been found that when the porosity is 9, 11%, RC15Y is relatively high showing 91, 89, respectively, and when the porosity is 20, 30%, RC15Y is very low showing 83, 77, respectively. Meanwhile, a ZrO₂-based ceramic layer with enhanced heat resistance has a low thermal conductivity. Further, the thermal conductivity of the ZrO₂-based ceramic layer is further lowered when the ZrO₂-based ceramic layer made porous to ensure abradability. Thus, frictional heat generated by wearing is stored to increase a temperature of a wear sliding portion. In some cases, the temperature locally reaches a melting temperature (about 1300° C.), which may reduce hardness of the Ni-based heat resistant alloy, or which may densify (increase in hardness of) a porous ceramic layer by sintering. Then, seizure occurs at the wear sliding portion and the abradability is reduced. And then, a moving blade tip is significantly damaged and worn down. For such generation and storage of friction heat, it is effective to radiate heat, as well as to reduce a contact area between the ceramic abradable layer and the moving blade in order to reduce a friction heat generation area. Specifically, it is important to form a slit groove in the ceramic abradable layer for heat radiation.

The inventors evaluated abradability at high temperature.

FIG. 4A is a schematic view of a high temperature wear test. In the test, the abradability was evaluated to a shroud temperature of the gas turbine. A ceramic abradable layer was provided on a bar member 11 facing a ring member 10 on a rotation side. The test was started after heating to a predetermined temperature with a heater 12. The ring material was assumed a moving blade, and the bar member was assumed a shroud. Both were made of a Ni-based heat resistant alloy.

The ceramic abradable coating has a configuration as shown in FIG. 1. A bond layer (0.1 mm), a thermal barrier ceramic layer (0.5 mm), and a ceramic abradable layer were sprayed in order. After spraying, a slit groove was formed in the ceramic abradable layer by machining. The slit groove substantially passed through the ceramic abradable layer. In the test, the rotational speed of the ring member 10 (outer diameter φ 25 mm) is 6000 rpm, the indentation load of the bar member 11 (10×10×40 mm) is sequentially increased, and the bar member 11 was indented to 80% of the thickness of the ceramic abradable layer.

As a result, when the abradability is not good, the ring member and the ceramic abradable layer are seized. When the abradability is good, there is no seizure between the ring member and the ceramic abradable layer, and the ceramic abradable layer is cut by the ring member.

As shown in FIG. 4B, the abradability is represented by a ratio (d/D) between the thickness (d) of the ring member 10 and the groove width (D) formed in the ceramic abradable layer on the surface of the bar member 11. When the abradability is good, the d/D is close to 1. The test was conducted at room temperature, 400° C., 600° C., and 800° C. In the test, the porosity of the ceramic abradable layer was adjusted to produce four levels of ceramic abradable layers having Rockwell superficial hardness (HR15Y) of 92, 89, 83, and 77. In this case, slits were formed in the ceramic abradable layer so that a slit interval is 2.8 mm and a slit groove width is 0.8 mm to form a rectangular section. A sliding direction is perpendicular to the slit groove. The ceramic abradable layer has a thickness of 1 mm. The result is shown in Table 1.

TABLE 1
Element wear test result 1

| Hardness | Temperature | | | |
|---|---|---|---|---|
| (RC15Y) | (° C.) | d/D | Note | Judgement |
| 92 | RT | 0.15 | | Poor |
| | 400 | — | Seizure | Poor |
| | 600 | — | Seizure | Poor |
| | 800 | — | Seizure | Poor |
| 89 | RT | 0.2 | | Poor |
| | 400 | — | Seizure | Poor |
| | 600 | — | Seizure | Poor |
| | 800 | — | Seizure | Poor |
| 83 | RT | 0.65 | | Good |
| | 400 | 0.6 | | Good |
| | 600 | 0.58 | | Good |
| | 800 | 0.58 | | Good |
| 77 | RT | 0.7 | | Good |
| | 400 | 0.65 | | Good |
| | 600 | 0.6 | | Good |
| | 800 | 0.6 | | Good |

(Rectangular width: 2.8 mm, ceramic abradable layer thickness: 1 mm)

When HR15Y is 92, 89, good abradability cannot be obtained at any test temperature. Meanwhile, when HR15Y is 83, 77, good abradability was obtained at all test temperatures.

Table 2 shows a result of changing the width of the rectangular section divided by the slit groove when HR15Y is 83.

TABLE 2
Element wear test result 2

| Rectangular | | | |
|---|---|---|---|
| width (mm) | d/D | Note | Judgement |
| 1.4 | — | Exfoliated during test | Poor |
| 2 | 0.6 | | Good |
| 2.8 | 0.65 | | Good |
| 4.6 | 0.6 | | Good |
| 7 | 0.65 | | Good |
| 10 | 0.25 | | Poor |

(RC15Y: 83, test temperature: 800° C., ceramic abradable layer thickness: 1 mm)

The test temperature was 800° C. From the test result with the ceramic abradable layer having a thickness of 1 mm, and the width of the rectangular section having five levels within a range of 1.4 to 10 mm, it was revealed that the slit groove was effective up to 7 mm. Meanwhile, the ceramic abradable layer having the width of 1.4 mm was exfoliated after the test.

Thus, it was found that a width of 2 to 7 mm was desirable. Table 3 shows a result of study of a relationship between the width of the rectangular section divided by the slit groove and the thickness of the ceramic abradable layer when HR15Y is 83.

TABLE 3
Element wear test result 3

| Rectangular | Thickness | | |
|---|---|---|---|
| width (mm) | (mm) | Note | Judgement |
| 2 | 1 | 0.55 | Good |
| | 2 | 0.6 | Good |
| | 3 | 0.6 | Good |
| 7 | 1 | 0.6 | Good |
| | 2 | 0.65 | Good |
| | 3 | 0.65 | Good |

(RC15Y: 83, test temperature: 800° C.)

The test temperature was 800° C. For both of the widths of 2 mm and 7 mm of the rectangular section, good abradability was obtained to a thickness up to 3 mm of the ceramic abradable layer. The thickness of 3 mm or more of the ceramic abradable layer is beyond a range of gap adjustment.

From the above-described results, it was found that for the abradability at a temperature of a shroud exposed to a combustion gas of the gas turbine, the rage with the Rockwell superficial hardness (BR15Y) of the ceramic abradable layer of 80±3, which is obtained by adjusting the porosity of the ceramic abradable layer, and with the width of 1.4 to 10 mm of the rectangular section divided by the slit groove, are a range with good abradability at the shroud temperature.

For thermal stress (repeated heating and cooling) at start and stop, a thermal cycle test of repeating heating and cooling was conducted. A test specimen had a size of 20×35×3 mm. A bond layer (thickness of 0.1 mm) and a thermal barrier ceramic layer (thickness of 0.5 mm) were formed. The porosity of the ceramic abradable layer was adjusted. On the layer, the test specimen includes a ceramic abradable layer having Rockwell superficial hardness (HR15Y) within a range of 80±3 of the ceramic abradable layer, a width of 1.4 to 10 mm of the rectangular section divided by the slit groove by machining, and a thickness of 1 to 3 mm. After the thermal cycle test (repeating 1000° C.×1 h and cooling) of the test specimen was repeated 1000 times, no damage such as exfoliation was found in any test specimen.

As a comparative material, the same thermal cycle test was conducted for a ceramic abradable layer in a known example shown in FIG. 2A. In this case, the ceramic abradable layer had an angular section, and the size of the bottom surface was 3 mm and the thickness (height) was 2 mm. Three ceramic abradable layers were provided at 6 mm pitch on a test specimen having a width of 200 mm. In this test specimen, the ceramic abradable layer was exfoliated and lost after the test was repeated about 250 times.

For durability to long-time exposure at high temperature, durability for 1000 times (1000 h) was confirmed by the thermal cycle test of repeating heating and cooling (holding for 1 h at 1000° C.).

### EXAMPLES

Now, a preferred example of the present invention and a comparative example will be described.

### Example 1

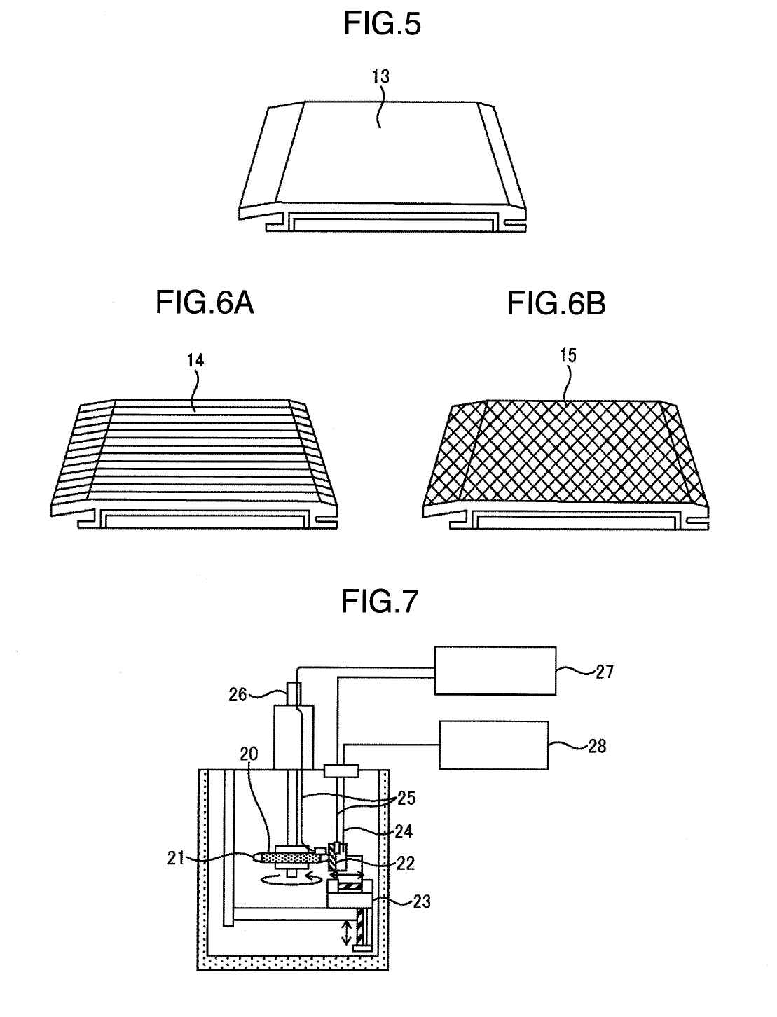

FIG. 1 is a sectional schematic drawing of an abradable coating produced by a method of forming an abradable coating in the present invention. FIG. 5 shows a shroud of a Ni-based heat resistant alloy used in the example. The shroud has a size of 75×145×18 mm. An abradable coating was applied to a hot gas path surface 13 of the shroud by a method of forming an abradable coating of the present invention.

An MCrAlY alloy is sprayed on a substrate as a bond layer. A spraying method is not particularly limited. Any method may be used, such as atmospheric plasma spraying, low pressure plasma spraying, high velocity gas spraying, or the like. In the example, CoNiCrAIY was sprayed by high velocity gas spraying. A spray film had a thickness of 0.1 mm.

Next, a thermal barrier ceramic layer is sprayed. A spraying method is not particularly limited. Any method may be used, such as atmospheric plasma spraying, low pressure plasma spraying, high velocity gas spraying, or the like. In the example, ZrO₂-8% Y₂O₃ was sprayed by atmospheric plasma spraying. A spray film had a thickness of 0.5 mm. Spraying conditions are: an N₂-H₂ gas, a plasma output of 30 kW, a spraying distance of 80 mm, a powder supply amount of 30 g/min, and using a Metco 9 MB gun.

Next, a ceramic abradable layer was sprayed. A spraying method is not particularly limited. Any method may be used, such as atmospheric plasma spraying, low pressure plasma spraying, high velocity gas spraying, or the like. In the example, a mixed powder of ZrO₂-8% Y₂O₃ and polyester powder was sprayed by atmospheric plasma spraying. A spray film had a thickness of 1 mm. Spraying conditions are: an N₂-H₂ gas, a plasma output of 30 kW, a spraying distance of 120 mm, a powder supply amount of 30 g/min, and using a Metco 9 MB gun. The mixed powder of ZrO₂-8% Y₂O₃ and polyester powder contained 25% polyester, and hardness (HR15Y) of the spray coating was 77.

Next, a slit groove was formed in the ceramic abradable layer by machining. A method of forming the slit groove is not particularly limited. The slit groove preferably has a depth to pass through the ceramic abradable layer. In the ceramic abradable layer, slits were formed with a slit interval of 5 mm and a slit groove width of 0.8 mm, and the ceramic abradable layer had a rectangular section.

FIG. 6A is a sketch of a shroud after the slits were formed. Slit grooves 14 were provided perpendicular to a rotational direction of the moving blade. In FIG. 6B, slit grooves 15 were provided perpendicular to each other in 45° direction. The direction and shape of the slit groove are not particularly limited, but a linear slit groove as shown in FIGS. 6A and 6B is preferable. With the same pattern as in FIG. 6B, a ceramic abradable layer was formed using a masking by the method in JP-A-2006-36632. In this case, the ceramic abradable layer had an angular section as shown in FIG. 2A.

A thermal cycle test of repeating heating to 1000° C. with holding for 1 h and cooling was conducted by using two types of the shrouds including abradable coating by the method of forming the abradable coatings in the present invention and one type of the shoroud including abradable coating by a known method. As a result, in the shroud having the abradable coating by the known method, a part of the abradable coating was exfoliated and lost after the test was conducted about 200 times. From the result of the check of the damaged part, it was found that there was an origin of the exfoliation at a lower end of the ceramic abradable layer having the angular section. The two types of the shrouds including the abradable coatings in the present invention were not damaged after the test was repeated 500 times, and were good condition. From the result after the test was repeated 500 times, there was no origin of the exfoliation or the like in any part in the ceramic abradable layer having a rectangular section.

### Example 2

An abradable coating was produced by the method of forming an abradable coating of the present invention in the same manner as in Example 1, and an abradability test by high-speed rotation was conducted.

FIG. 7 shows a configuration diagram of the test. In the test, a test specimen 22 mounted on a traverse device 23 was indented against a tip of a test blade 21 mounted on a test rotor 20 φ 200 mm) rotating at high speed. A blade portion of the test blade had a length of 22 mm, a width of 20 mm, and a thickness of 6 mm. The test specimen including the abradable coating in the present invention was a flat plate of 60×60 mm. A test machine includes a thermocouple 24 for measuring a temperature of the test specimen, a strain gauge measuring line 25 for measuring strain, a slip ring 26 for the measuring line, a strain measuring portion 27, and a temperature measuring portion 28. The abradable coating in the present invention includes a ceramic abradable layer having slit grooves perpendicular to each other as shown in FIG. 6B.

As a comparison, an abradable coating including a ceramic abradable layer having an angular section as in Example 1 was also produced. Test specimens including these two types of abradable coatings were used to conduct a rotation test. In the tests at rotor rotational speed of 10000, 20000, and 33000 rpm, there was no damage of the abradable coating after the test in the test specimen including the abradable coating in the present invention. And there was a sliding mark of the moving blade in the ceramic abradable layer. There was almost no damage by wearing on the moving blade tip.

Meanwhile, in the abradable coating test specimen including the ceramic abradable layer having an angular section produced as a comparison, a part of the ceramic abradable layer was exfoliated and lost after the test. The moving blade tip was seized by wearing damage.

The above results revealed that the abradable coating by the method of forming an abradable coating of the present invention has good abradability in the abradable test using a rotation device.

### Example 3

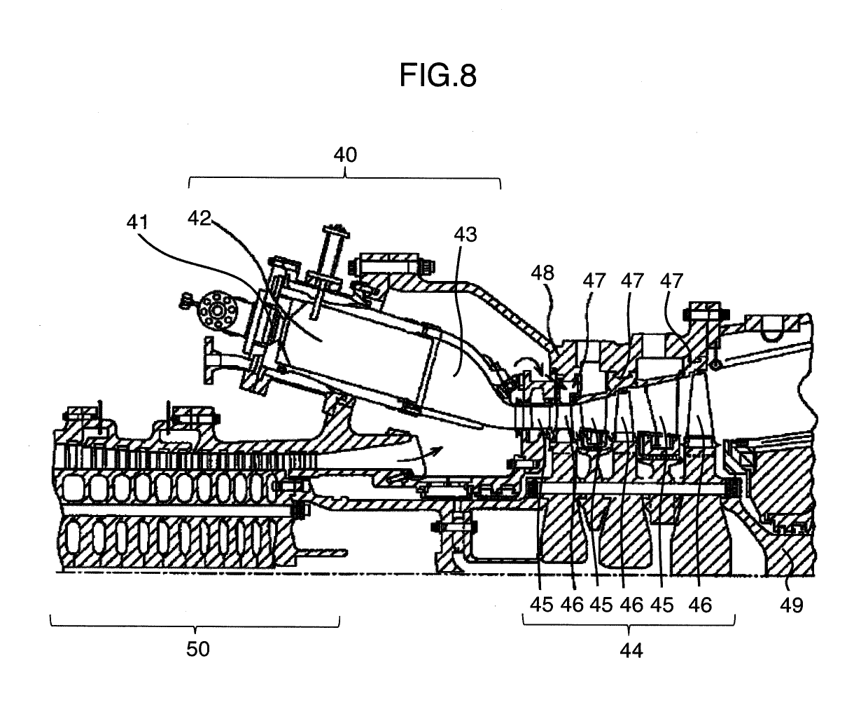

FIG. 8 is a sectional schematic diagram of main parts of a power generation gas turbine. The gas turbine includes, in a turbine casing 48, a rotating shaft (rotor) 49 at a center, and a turbine portion 44 having moving blades 46 placed around the rotating shaft 49, stationary blades 45 supported by the casing 48, and turbine shrouds 47. The gas turbine includes a compressor 50 and a combustor 40. The compressor 50 is connected to the turbine portion 44, sucks air in, and obtains compressed air for combustion. The combustor 40 includes a combustor nozzle 41 that mixes and injects the compressed air supplied from the compressor 50 and supplied fuel (not shown). The air/fuel mixture is burned in a combustor liner 42 to generate a high-temperature high-pressure combustion gas. The combustion gas is supplied to the turbine 44 via a transition piece 43, and thus a rotor 49 is rotated at high speed. A part of the compressed air discharged from the compressor 50 is used as internal cooling air of the liner 42 in the combustor 40, the transition piece 43, the turbine stationary blade 45, the turbine moving blade 46, and the turbine shroud 47. The high-temperature high-pressure combustion gas generated in the combustor 40 passes through the transition piece 43, and is rectified by the turbine stationary blade 45 and injected to the moving blade 46 to rotationally drive the turbine portion 44. Generally, a not-shown power generator connected to an end of the rotating shaft 49 generates power.

In this example, the shroud including the ceramic abradable layer in the present invention in Examples 1 and 2 described above was used as the turbine shroud 47 facing a first stage moving blade 46. The shroud in FIGS. 6A and 6B in Example 2 was an individual shroud segment, and shroud segments were mounted to a shroud body to constitute the turbine shroud 47 as a ring-shaped inner shroud.

In the gas turbine using the gas turbine shroud in which the ceramic abradable coating in the present invention was placed on the hot gas path surface of the shroud facing the gas turbine moving blade, a gap between the moving blade and the shroud could be reduced. And then, the reduction in the gap increased gas turbine efficiency about 1%.

In this example, the present invention was used as the inner shroud that constitutes the turbine shroud 47 facing the first stage moving blade 46 of the turbine portion 44 including three stages. However, the present invention may be used as a turbine shroud 47 facing a second or third stage moving blade in latter stages. The turbine shroud 47 in the latter stages sometimes has as structure only having a shroud body without an inner shroud. In this case, the present invention may be used in a hot gas path surface facing a moving blade of the shroud body. In the example, the gas turbine includes three stages, but the shroud of the present invention may be used in a gas turbine including four stages.

It should be further understood by those skilled in the art that although the foregoing description has been made on embodiments of the invention, the invention is not limited thereto and various changes and modifications may be made without departing from the spirit of the invention and the scope of the appended claims.

1. A gas turbine shroud, wherein a ceramic abradable coating is placed on a hot gas path surface of the shroud facing a gas turbine moving blade, the ceramic abradable coating being obtained by spraying a bond layer on a substrate, spraying a thermal barrier ceramic layer on the bond layer, spraying an abradable ceramic layer on the thermal barrier ceramic layer, and forming a slit groove in the abradable ceramic layer by machining.

2. The gas turbine shroud according to claim 1, wherein the abradable ceramic layer divided by the slit groove has a rectangular section, and a slit groove width is 0.5 to 2 mm.

3. The gas turbine shroud according to claim 1, wherein the abradable ceramic layer sprayed on the thermal barrier ceramic layer has Rockwell superficial hardness (HR15Y) of 80±3.

4. A gas turbine comprising a gas turbine shroud according to any one of claims 1 to 3.

5. A method of forming a ceramic abradable coating placed on a hot gas path surface of a shroud facing a gas turbine moving blade, comprising the steps of:
spraying a bond layer on a substrate; spraying a thermal barrier ceramic layer on the bond layer; spraying an abradable ceramic layer on the thermal barrier ceramic layer; and
forming a slit groove in the abradable ceramic layer by machining.
